(19) United States
(12) Patent Application Publication
(10) Pub. No.: US 2011/0197264 A1
(43) Pub. Date: Aug. 11, 2011

(54) SYSTEM AND METHOD FOR REMOTE MEDIA ACCESS

(75) Inventor: Darryn D. McDade, Livermore, CA (US)

(73) Assignee: STMicroelectronics, Inc., Coppell, TX (US)

(21) Appl. No.: 13/023,409

(22) Filed: Feb. 8, 2011

Related U.S. Application Data
(60) Provisional application No. 61/302,355, filed on Feb. 8, 2010.

(51) Int. Cl. G06F 21/00; G06F 15/16

(52) U.S. Cl. 726/4; 709/219

(57) ABSTRACT

Embodiments of the present disclosure provide a system and method for remotely accessing media content. The method includes receiving authentication information originating from a communication device associated with a user. Media content that is stored on a media storage device associated with the user is also received. Digital rights management software is applied to the media content, and the received media content is communicated to the communication device.

### CROSS REFERENCE TO RELATED APPLICATIONS

This application claims the benefit of U.S. Provisional Application No. 61/302,355 filed on Feb. 8, 2010, which is incorporated herein by reference.

### TECHNICAL FIELD

The present disclosure generally relates to media access and delivery, and more particularly to a system and method for accessing media remotely using a communication device.

### BACKGROUND

Digital media content is readily available and can be played by a variety of devices. Digital media may be computer files that represent songs or other audio content, videos, still photographs and the like. Digital Rights Management (DRM) software attempts to control which devices are authorized to play certain digital media files. Owners of digital media files may have these files stored on a central device that may be physically located at the user's home or office. This central device may use DRM software to allow the playing of digital media files. Many digital devices that are operable to play digital media are also able to send and receive communications over cellular and/or packet-switched communications networks.

### SUMMARY

Embodiments of the present disclosure provide a system and method for remotely accessing media content. The method includes receiving authentication information originating from a communication device associated with a user. Media content that is stored on a media storage device associated with the user is also received. Digital rights management software is applied to the media content, and the received media content is communicated to the communication device.

Further embodiments of the present disclosure may include communicating a list of media content identifiers to the communication device. A selection of one of the media content identifiers identifying the media content may be received, which may initiate streaming of the media content to the communication device.

Embodiments of the present disclosure may allow a user to enjoy audio content that he has purchased without having it stored locally on his mobile device. The user may maintain a library of media content on a storage device physically located at the user's home or office. The user may then be able to access this content and stream it to his mobile device.

Further technical advantages include having digital rights management software applied to the media content by a computer device associated with the storage device located at the user's home or office. Although the DRM software is applied by the computer device, the media content may be played remotely by the user's mobile communication device.

Other technical features may be readily apparent to one skilled in the art from the following figures, descriptions, and claims.

### BRIEF DESCRIPTION OF THE DRAWINGS

A more complete understanding of the disclosure may be obtained by reference to the following drawings:

FIG. 1 schematically illustrates a remote media access system according to an embodiment of the present disclosure;

FIG. 2 schematically illustrates components of a computer system according to an embodiment of the present disclosure; and

FIG. 3 is a flow diagram illustrating a method for remote media access according to an embodiment of the present disclosure.

### DETAILED DESCRIPTION

The present disclosure generally provides systems and methods for delivering and remotely accessing media content. The media may be stored in a memory module associated with a computer system located in a user's home or office. The user may use digital rights management (DRM) software to play the media on the home/office computer system, such as a desktop computer, a laptop computer, or a set-top box associated with receiving television programming. The home/office computer system or player may communicate the media over a communications network to a proxy server, which may forward the packets of media to an endpoint. The endpoint may be a mobile communication device associated with the user. The user may communicate a username and password from the mobile device to the proxy server to access the media and have it forwarded by the proxy server to the user's mobile device.

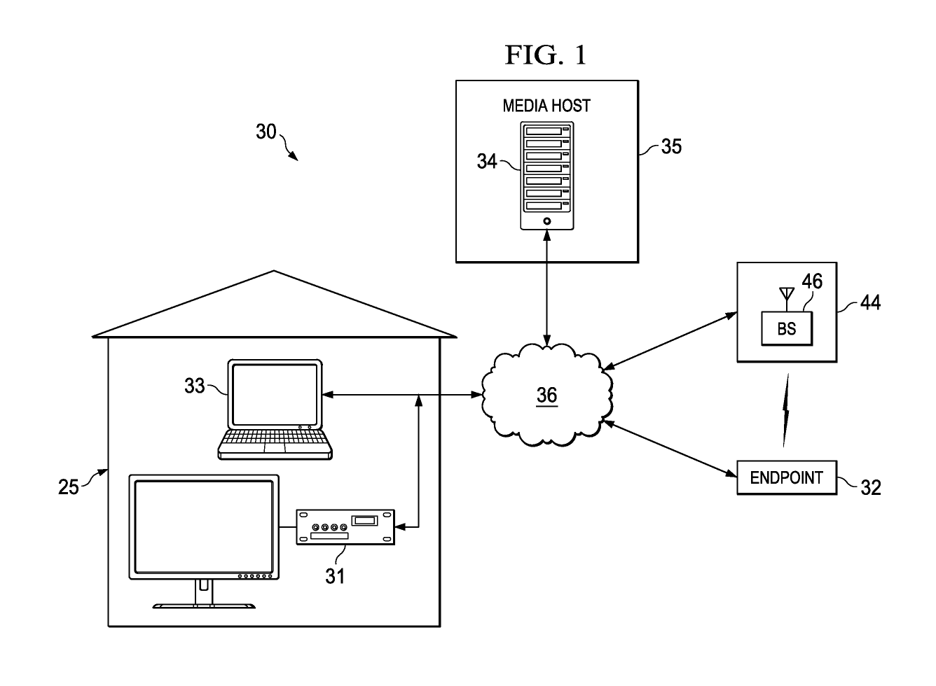

It should be understood that the diagrams shown in FIGS. 1-3 are for illustrative purposes only and that other suitable remote media access systems and methods may be used in conjunction with or in lieu of the illustrated systems and methods according to embodiments of the present disclosure.

Referring to the drawings, and particularly to FIG. 1, a remote media access system 30 according to embodiments of the present disclosure is illustrated. The remote media access system 30 includes an endpoint 32, which has the ability to establish communication sessions between other endpoints and/or a proxy server 34 using communication network 36 and/or mobile communications network 44. The endpoint 32 may be any suitable communication device including a mobile communication device operable to send and receive audio and video content, voice, and text communications, such as a mobile phone, smart phone, tablet computing device, or laptop computer.

The endpoint 32 may also have functionality to allow it to receive communications including media content and to play or render the media. In certain embodiments, the endpoint 32 may not store the media locally, but rather may stream or relay the media. When media is streamed, it may be received and played by the endpoint 32, but the endpoint 32 may not store the media, such that it may be accessed at a later time by a user using the endpoint 32 without being received again. In certain embodiments, the endpoint 32 may not have sufficient memory to allow storage of large media files. In other embodiments, the endpoint 32 may have sufficient memory for such storage, but it may not be desirable to consume such memory with audio or video files. According to an embodiment of the present disclosure, the endpoint 32 may be a mobile telephone that may play audio or video media and display still images, such as photographs. The endpoint 32 may also be a mobile device other than a telephone that is operable to communicate over a mobile telephone or other type of communications network.

The endpoint 32 may receive and transmit packets or other signals. For example, the endpoint 32 may communicate packets through a communication network 36, which may be a packet-switched communications network, such as the Internet. The communication network 36 may be any network capable of transmitting audio and/or video telecommunication signals, data, and/or messages, including signals, data or messages transmitted through text chat, instant messaging and e-mail across multiple cities and geographic regions. The communication network 36 may be implemented as a local area network (LAN), wide area network (WAN), global distributed network such as the Internet, an intranet, extranet, or any other form of wireless or wireline communication network. Generally, the communication network 36 provides for the communication of packets, cells, frames, or other portions of information between endpoint 32, computer 33 or set-top box 31, and/or proxy server 34. The communication network 36 may enable communications between and among any number and combination of endpoints and/or computers/servers.

The endpoint 34 may also communicate through mobile communications network 44, which may be a cellular network. The primary function of mobile communications network 44 may be to allow mobile telephones to communicate with each other and landline telephones. A variety of communication protocols may be accommodated by the endpoint 32 and the mobile communications network 44. For example, some communication technologies include frequency division multiple access (FDMA), time division multiple access (TDMA), code division multiple access (CDMA), global system for mobile communications (GSM), and the like. Third generation (3G), fourth generation (4G), and WiMax mobile communication technologies may be accommodated by mobile communications network 44 and endpoint 32. In certain embodiments, the communications network 44 may include a plurality of base stations 46. The base station 46 may include an antenna and other components that enables and controls communications among communication devices using the mobile communication network 44, for example the endpoint 32.

Audio, video, or other media may be stored on a computer 33, on set-top box 31, or similar device. These devices may be any type of computing device that receives input data, processes that data through computer instructions in a program, and generates output data. Such device may be a hand-held device, tablet, laptop or notebook computer, desktop computer, minicomputer, mainframe, server, mobile phone, smart phone, personal digital assistant, other device, or any combination thereof. The computer 33 and/or set-top box 31 may be physically located in an office or home 25.

These devices may store digital media files that include audio and/or video content. These devices may have downloaded this media content from the Internet or other network and paid a fee for the right to play the media without violating one or more copyrights associated with the media content. In certain instances, the replay of the media may be controlled by digital rights management (DRM) software associated with the digital media file and installed on the computer 33. The digital rights management software may control which devices are authorized and able to play the media. DRM technology may rely on interaction between the media content and the system that plays it. Some DRM technology and/or software applications that may be used according to embodiments of the present disclosure include, but are not limited to: Windows Media-DRM, Janus (provided by Microsoft®); MS PlayReady/Silverlight (provided by Microsoft®); Verimatrix (provided by Zillion®); FairPlay (provided by Apple®); OMA (Open Mobile Alliance); BD+ for Blue Ray Discs; OpenMG (provided by Sony®); and Marlin (provided by Intertrust®).

As an example, a user may have used the computer 33 to purchase a song in the form of a digital media file, such as an .mp4 file. The purchase may have only entitled the user to play the song on the computer 33. To ensure that the computer 33 is the only device that with the ability to play the .mp4 file, the file may be encrypted and only play once the appropriate key is provided by the computer 33. Once the computer 33 negotiates the DRM using the key associated with the particular file, the song may be played by the computer 33. In other instances, the song may be owned by the user because the user purchased a compact disc including the song. The user may have uploaded the song from the compact disc such that an authorized copy of the song resides in a digital file accessible by the computer 33. In this instance the digital file may be clear and not require any DRM technology to play the file.

It will be recognized by those of ordinary skill in the art that computer 33, set-top box 31, and proxy server 34 may be any combination of hardware, software, and/or encoded logic that provide communication services to a user. For example, endpoints 32 may include a telephone, a computer running telephony software, a video monitor, a camera, an Internet Protocol phone, a cell phone or any other communication hardware, software, and/or encoded logic that supports the communication of packets of media (or frames) or other signals using communication network 36 and/or mobile communication network 44. Although FIG. 1 illustrates a particular number and configuration of endpoints, computers, and servers, the remote media access system 30 contemplates any number or arrangement of such components for communicating media.

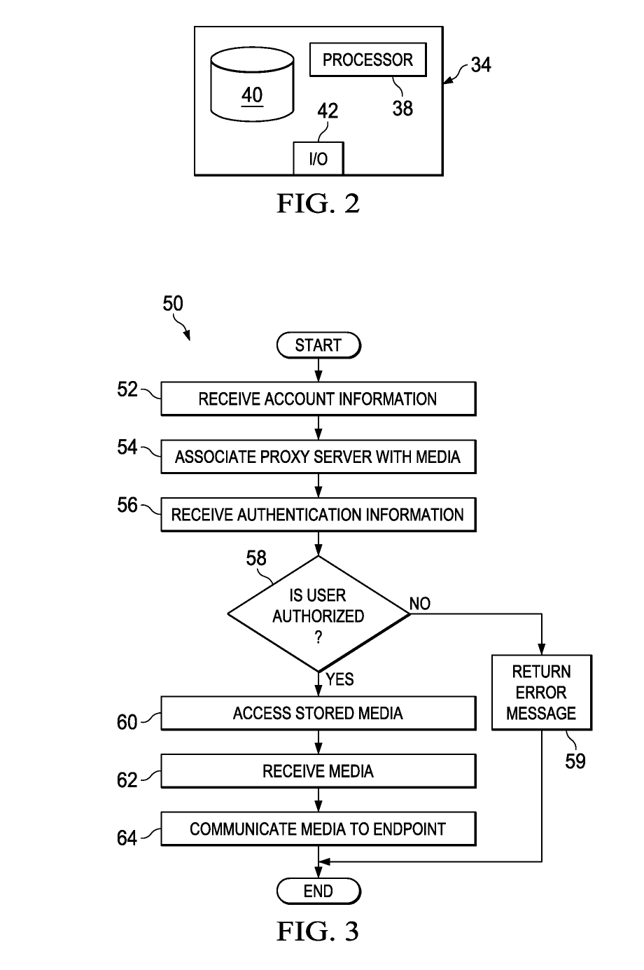

The communication devices according to the present disclosure, for example the proxy server 34 may include a processor 38, a memory module 40, and an interface as illustrated in FIG. 2. The interface 42 may serve to couple the proxy server 34 with the communication network 36. The processor 38 may use a memory lookup, a database or other memory module, such as memory module 40, in performing sending and receiving information, such as user identification information or audio or video media and other operations according to embodiments of the present disclosure. The processor 38 may be a microprocessor, controller, or any other suitable computing device or resource. The memory module 40 may be any form of volatile or non-volatile memory including, without limitation, magnetic media, optical media, random access memory (RAM), read-only memory (ROM), removable media, or any other suitable local or remote memory component.

The proxy server 34 may be associated with a media host 35. The media host 35 may be an entity that provides web services that enable cloud computing. Web services that may be used according to an embodiment of the present disclosure include, but are not limited to, those provided by Google®, Microsoft Azure®, and Amazon® Web Services. In certain embodiments, the media host 35 may own and operate the proxy server 34 and may generate revenue by charging a fee to access media from the computer 33 where it is stored and forward through a media stream to the endpoint 32. In other embodiments, the proxy server 34 may store media received from the computer 33 or set-top box 31 in a memory module where it may be accessed and streamed to the endpoint 32.

It will be recognized by those of ordinary skill in the art that proxy server 34 may include any number of processors or memory modules to accomplish the functionality and features described herein. The processor 38 and/or memory module 40 associated with the proxy server 34 may be centrally located (local) with respect to one another, or distributed throughout a communication network. Furthermore, any or all of the components illustrated as part of proxy server 34 may be separate from proxy server 34 and/or distributed locally or remotely from proxy server 34.

FIG. 3 illustrates a flow diagram of a method 50 for a user to access media content remotely. The method begins at step 52 where account information is received. The account information may be received by the proxy server 34 or other computer system associated with the media host 35. The account information may include a username and a password. The username and password may be supplied by a user or may be generated by the proxy server 34. Other personally identifiable information may also be provided by the user, such as the user's name, address, etc. In certain embodiments, the user may provide a payment method to use the media forwarding service offered by the media host 25. According to an embodiment of the present disclosure, the user may also provide identification information associated with the endpoint 32 as part of the account information. For example, the user may provide a telephone number to identify a mobile phone that may be the endpoint 32. By providing identification information associated with the endpoint 32, it may be verified that the endpoint 32 is the device that is receiving the media streamed from the proxy server 34. Thus, the user may be prohibited from creating an account and giving the account identification information to a user that would not be authorized to replay the media pursuant to the DRM.

At step 54, the proxy server may be associated with the media. In certain embodiments, this may be accomplished by directing the proxy server to access memory associated with the computer 33, which stores the media. The media may be stored as individual songs or videos, as a collection of works by a particular performance artist, or a playlist created by the user. The user may have obtained digital rights in the media at the time the media was purchased or otherwise obtained by the user. As previously stated, the digital rights may be negotiated by the computer 33 or other device upon each event of playing of the media.

When the user desires to access the media remotely, he may provide authentication information that may be received by the proxy server 34 at step 56. In certain embodiments, the user may direct the endpoint 32 to a website associated with the proxy server 34. The website may prompt the user to provide a username and a password as authentication information. The user may enter this information on a keypad of the endpoint 32. In other embodiments, the authentication information may be provided by the voice of the user speaking a particular word or phrase. The voice and/or word or phrase may be interpreted and recognized by the proxy server 34.

At step 58, it is determined whether the user is authorized. The proxy server 34 may compare the authentication information provided by the user to information or data previously stored by the proxy server 34 and previously associated with the account of the user. If the authentication information is determined to be invalid, and the user is not authorized to access a user account associated with the proxy server 34, the method proceeds to step 59 and an error message is returned to the user.

If the authentication information is determined to be valid, and the user is authorized to access a user account associated with the proxy server 34 and the media host 25, the method proceeds to step 60 where the stored media is accessed by the proxy server 34. Accessing the stored media may include the proxy server sending a command over the communication network 36 to the computer 33 instructing it to play particular media content selected by the user. In other embodiments, a command sent from the proxy server 34 may instantiate on the endpoint 32 a virtual machine or instance of the playing technology, software, or device associated with computer 33 or set-top box 31. The media content stored on computer 33 or set-top box 31 may streamed to this virtual machine implemented on the endpoint 32.

The user may select the desired media from a list of the user's saved content that was previously associated with the user's account. This list may be provided by the website of the media host 35. Upon receiving the play command from proxy server 34, the computer 33 may retrieve the selected media and initiate the process of playing the media. This may include negotiating the DRM associated with the selected media. Negotiating the digital rights may include using DRM software that includes a key that allows the media to be decrypted to allow it to be played by the computer 33. As part of playing the media, the computer 33 may communicate the media over the communication network 36 to the proxy server 34. According to one embodiment, a playback application of computer 33 or set-top box 31 may negotiate or apply DRM technology and play the media content. In this embodiment the playback may actually occur on the monitor and or speakers associated with the computer 33 or set-top box 31 as well as communicating the content to proxy server 34.

According to another embodiment, a virtual display monitor and/or virtual speaker may be embodied in a device driver, which may encode and compress the media content communicated to the proxy server 34. In this instance, there may not be actual playback occurring on the monitor and or speakers associated with the computer 33 or set-top box 31. In addition, a DRM key associated with the computer 33 or set-top box 31 may be used to decrypt the media content; then a second DRM key may be used to encrypt the content. The second encryption may allow the media content to be communicated in encrypted form such that there is no clear content that may be received without authorization through the communications network 36. In this embodiment, the proxy server 34, the endpoint 32, or other device associated with the remote media access system 30 may include software that may decode the second DRM key.

At step 62, the media may be received by the proxy server 34. The received media may be stored by the proxy server 34 or it may be received as a stream that may not be stored for any substantial time, but rather may be played and thereafter marked for deletion. In other embodiments, the proxy server 34 may buffer or temporarily store a portion of the received media. When a predetermined amount of the media is received by the proxy server 34, the media may be released by the buffer for content rendering. In other embodiments, the content may be communicated in its entirety by the computer 33 and the entire media file may be received and stored by the proxy server 34 before it is forwarded to the endpoint 32.

At step 64, the proxy server 34 may communicate the media to the endpoint 32. The media may be communicated through the communication network 36 and/or the mobile communications network 44. The endpoint 32 may receive the media as a stream of data that it may play to the user. In certain embodiments, the user may use the remote media access system 30 to access a music file that is stored on his computer 33 and which the computer 33 is authorized to play. The user may enjoy listening to the music file on a mobile phone remote from his home or office 25 by receiving the media file forwarded by the proxy server 34 where it may be streamed by the mobile communication device or endpoint 32. Similarly, if the mobile phone that embodies the endpoint 32 is enabled to play video media content, the user can access a video file that is stored on set-top box 31, and have that file streamed from the proxy server 34 to his video enabled mobile phone that is remote from the user's home/office 25.

Some of the steps illustrated in FIG. 3 may be combined, modified, or deleted where appropriate, and additional steps may also be added to the flow diagrams. Additionally, steps may be performed in any suitable order without departing from the scope of the invention.

As will be appreciated by one skilled in the art, the present disclosure may be embodied as a system, method or computer program product. Accordingly, embodiments of the present disclosure may take the form of an entirely hardware embodiment, an entirely software embodiment (including firmware, resident software, micro-code, etc.), or an embodiment combining software and hardware aspects that may all generally be referred to herein as a circuit, module or system. Furthermore, embodiments of the present disclosure may take the form of a computer program product embodied in any tangible medium of expression having computer-usable program code embodied in the medium.

Any combination of one or more computer usable or computer readable mediums(s) may be utilized. The computer-usable or computer-readable medium may be, for example but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device.

It may be advantageous to set forth definitions of certain words and phrases used in this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations, and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure and the following claims.

1. A method of remotely accessing media content, comprising:
receiving by a proxy server authentication information originating from a remote communication device associated with a user;
receiving by the proxy server media content stored on a media storage device associated with the user; and
communicating the received media content to the remote communication device.

2. The method of claim 1 wherein the media content has digital rights management software applied thereto.

3. The method of claim 1, further comprising communicating by the proxy server a play command to the media storage device after receiving the authentication information.

4. The method of claim 1, further comprising:
communicating by the proxy server a list of media content identifiers to the remote communication device; and
receiving by the proxy server a selection of one of the media content identifiers identifying the media content.

5. The method of claim 1, further comprising:
receiving by the proxy server an identifier associated with the remote communication device; and
verifying the identifier before communicating the received media content to the remote communication device.

6. The method of claim 1, further comprising:
receiving, by the proxy server, account information from the user, the account information being a basis of a user account; and
wherein the received authentication information allows the user to access the user account.

7. The method of claim 1 wherein the media content is streamed by the remote communication device.

8. The method of claim 1 wherein the media storage device comprises a set-top box associated with receiving television programming.

9. The method of claim 1 wherein the media content comprises a file that includes audio content.

10. The method of claim 1 wherein:
the media content has digital rights management software applied thereto; and
the digital rights management software application comprises verifying a key associated with the media content.

11. The method of claim 1 further comprising storing, by the proxy server, the received media content before communicating the media content to the remote communication device.

12. A remote media content access system, comprising:
a proxy server having a processor coupled to a memory module, the processor being programmed to perform functions comprising:
receiving authentication information originating from a remote communication device associated with a user;
receiving media content stored on a media storage device associated with the user, the media content having digital rights management software applied thereto; and
communicating the received media content to the remote communication device.

13. The system of claim 12 wherein the processor is programmed to perform functions further comprising communicating a play command to the media storage device after receiving the authentication information.

14. The system of claim 12 wherein the processor is programmed to perform functions further comprising:
communicating a list of media content identifiers to the remote communication device; and
receiving a selection of one of the media content identifiers identifying the media content.

15. The system of claim 12 wherein the processor is programmed to perform functions further comprising:
receiving an identifier associated with the remote communication device; and
verifying the identifier before communicating the received media content to the remote communication device.

16. The system of claim 12 wherein the processor is programmed to perform functions further comprising:
receiving account information from the user, the account information being a basis of a user account; and
wherein the received authentication information allows the user to access the user account.

17. The system of claim 12 wherein the media content is streamed by the remote communication device.

18. The system of claim 12 wherein the media storage device comprises a set-top box associated with receiving television programming.

19. The system of claim 12 wherein the media content comprises a file having audio content.

20. The system of claim 12, wherein the processor is programmed to perform functions further comprising storing the received media content before communicating the media content to the remote communication device.

21. A remote media access system, comprising:
a media content storage device;
a remote communication device; and
a proxy server operable to:
receive authentication information originating from the remote communication device associated with a user;
communicate a list of media content identifiers to the remote communication device;
receive a selection of one of the media content identifiers;
communicate a command to the media content storage device to initiate communication of media content associated with the one of the media content identifiers;
receive the media content stored on the media content storage device associated with the user; and
relay the received media content to the remote communication device;
wherein the media content storage device stores the media content and is operable to communicate the media content to the proxy server and further operable to apply digital rights management software to the media content; and
wherein the remote communication device is operable to receive the media content from the proxy server and further operable to render the received media content.
